(19) United States
(12) Patent Application Publication
(10) Pub. No.: US 2026/0225318 A1
(43) Pub. Date: Aug. 6, 2026

(54) 5D PRINTING WITH DYNAMICALLY COLLABORATING ROBOTIC SYSTEMS

(71) Applicant: INTERNATIONAL BUSINESS MACHINES CORPORATION, Armonk, NY (US)

(72) Inventors: Martin G. Keen, Cary, NC (US); Carolina Garcia Delgado, Zapopan (MX); Sarbajit Kumar Rakshit, Kolkata (IN); Aaron Keith Baughman, Cary, NC (US)

(21) Appl. No.: 19/045,881

(22) Filed: Feb. 5, 2025

(51) Int. Cl. B29C 64/379; B29C 64/393; B33Y 10/00; B33Y 50/02

(52) U.S. Cl. CPC B29C 64/379; B29C 64/393; B33Y 10/00; B33Y 50/02

(57) ABSTRACT

Methods and systems for five-dimensional printing include monitoring motion of a piece held by a gripping arm during an automated manufacturing process. A parameter of the automated manufacturing process or of the gripping arm is adjusted to compensate for the motion.

### BACKGROUND

The present invention generally relates to five-dimensional (5D) printing and, more particularly, to robotic systems for manipulating a piece and performing additive or subtractive processes on the piece.

5D differs from three-dimensional (3D) printing in that the orientation between a tool and a piece may be changed by rotating in two degrees of freedom. This makes it possible to apply the tool to sides of the piece that would otherwise be inaccessible, thereby increasing the diversity of shapes and structures that can be formed. However, the tool may cause forces on the piece that are difficult to predict, so that it is difficult to ensure that the piece accurately reflects a design.

### SUMMARY

A method for five-dimensional printing includes monitoring motion of a piece held by a gripping arm during an automated manufacturing process. A parameter of the automated manufacturing process or of the gripping arm is adjusted to compensate for the motion.

A computer program product includes one or more computer-readable storage media and program instructions stored on the one or more computer-readable storage media to perform operations. The operations include monitoring motion of a piece held by a gripping arm during an automated manufacturing process and adjusting a parameter of the automated manufacturing process or of the gripping arm to compensate for the motion.

A computer system includes a processor set, one or more computer-readable storage, and program instructions stored on the one or more computer-readable storage media to cause the processor set to perform operations. The operations include monitoring motion of a piece held by a gripping arm during an automated manufacturing process and adjusting a parameter of the automated manufacturing process or of the gripping arm to compensate for the motion.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a diagram of a five-dimensional (5D) printing system that adjusts parameters of a gripping arm and of a printing process to compensate for forces exerted by the printing process, in accordance with an embodiment of the present invention;

FIG. 2 is a block/flow diagram of a method for performing a 5D printing process with collaboration between robotic systems, in accordance with an embodiment of the present invention;

FIG. 3 is a block diagram of a method for adjusting the parameters of a robotic system in a 5D printing process, in accordance with an embodiment of the present invention; and

FIG. 4 is a block diagram of a computing environment that can provide robotic collaboration between systems in a 5D printing process, in accordance with an embodiment of the present invention.

### DETAILED DESCRIPTION

A five-dimensional (5D) fabrication system may include two robotic systems—a first system to hold a piece and a second system with a tool to perform additive or subtractive process on the piece. When the second system works on the piece, it applies forces to the piece that can cause movement and vibrations. Furthermore, the addition or removal of material from the piece may cause the weight distribution of the piece to change. While the first system attempts to compensate for these movements and changing forces, the first system may be unable to respond quickly enough or with sufficient to force to completely immobilize the piece.

Adjustments may therefore be needed during the fabrication process. For example, instructions may be sent to the second system to adjust the parameters of the work it is doing. Such instructions may include changing a force that is applied to the piece or changing a tool speed. Instructions may similarly be sent to the first system to change the force it applies to hold the piece in place, or to otherwise compensate for the forces being applied by the tool of the second system.

Because the effects of the additive or subtractive process may be difficult to predict, the effects on the piece are monitored so that adjustments may be made in real time. In this way arbitrary robotic systems may be used together without precalibration, substantially reducing the amount of time needed to configure tooling for a particular piece and further reducing the effort needed in creating a working design.

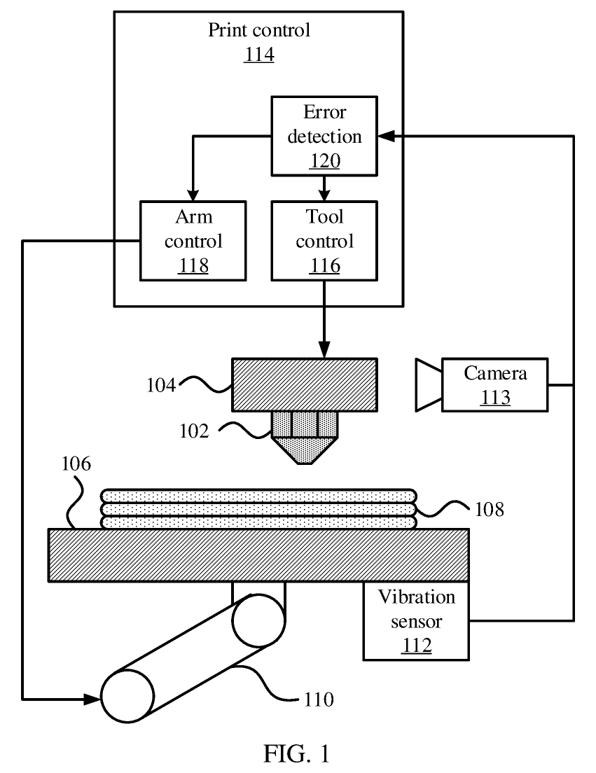

Referring now to FIG. 1, a diagram of 5D fabrication system is shown. A print head 102 is attached to a gantry 104 or other fixture that moves laterally over a print bed 106. As the print head moves, it extrudes a print material, which is deposited on the print bed 106. After a full layer is deposited, the gantry 104 moves the print head 102 vertically and a next layer is deposited on top of the previous layer. As multiple layers 108 are formed on top of one another, a 3D object is formed in accordance with an input design.

In some embodiments, the layers 108 may be formed from polyethylene terephthalate glycol (PETG), a thermoplastic, but it should be understood that other materials may be used instead. This view of a 3D printing system is intended to be purely exemplary and should not be regarded as limiting—other types of 3D printing are contemplated and fall within the scope of the present principles. This shows one form of additive manufacturing, referred to as fused deposition modeling.

Other types of additive and subtractive manufacturing are contemplated. For example, subtractive manufacturing may replace the print head 102 with a tool, such as a mill or drill, that removes material from the layers 108 or from any other appropriate piece that is being worked on. Exemplary types of tools include high-speed spindles, lasers, and additive manufacturing nozzles. Regardless of the type of tool, the gantry 104 may be implemented as a robotic system that maneuvers the tool in three-dimensional space relative to the piece.

In a 5D printing system, the print bed 106 may be configured to rotate in one or more dimensions, so that a next layer may be deposited along a plane that is different from the prior layers 108, or so that material removal may be performed on a surface or at an angle that would otherwise not be accessible. The print bed 106 may therefore be mounted to another robotic system that includes a gripping arm 110 to control its orientation along one or more axes.

It is specifically contemplated that the gripping arm 110 may be able to orient the print bed or piece in two rotational dimensions. In some cases the gripping arm 110 may be implemented as a general purpose robotic system that is not calibrated for any particular additive or subtractive process. The gripping arm 110 will have tolerances and limitations in its ability to hold the piece steady under the forces applied by the tool.

During the additive or subtractive process, the operation of the tool changes the force that is applied to the piece. In the case of an additive process, the addition of new material changes the weight of the piece and can further change the distribution of weight, causing the force of gravity exerted by the piece on print bed 106 to change. In the case of a subtractive process, not only does the removal of material cause the weight of the piece to change in a similar manner, but the operation of the tool itself exerts forces on the piece and can result in pressure and vibrations that can move the piece out of its intended location. During a 5D printing process, imperfect alignment between the different planes can result in material being deposited in a location, or removed from a location, that is not intended.

During the additive or subtractive process, a vibration sensor 112 may monitor the print bed 106 to determine when the tool is causing the piece to shake. Cameras 113 may monitor the print-in-progress as well and may identify when the piece moves out of position. There may be multiple cameras 113 that view the print-in-progress from different angles. Information from the vibration sensor 112 and images from the cameras 113 are sent to a print control 114 which uses error detection 120 to identify when the tool is causing movement of the piece. In addition to the vibration sensor 112 and cameras 113, other types of sensor are also contemplated, such as temperature sensors, torque sensors, and force sensors.

The print control 114 uses information gleaned from the error detection 120 to operate tool control 116 and arm control 118. The tool control 116 may, for example, be used to change operational parameters of the fabrication process. In the example of a subtractive process, tool control 116 may reduce a tool speed to reduce vibrations or may change a force exerted by the tool to reduce unintended displacement of the piece. Other types of parameters that may be adjusted include filament feed rate and laser intensity. The arm control 118 may send instructions to the gripping arm 110 to compensate for forces exerted by the tool or to respond to the changing weight of the piece. In some cases the print control 114 may be integrated with the robotic system of the tool, with the robotic system of the gripping arm 110, or as a separate component.

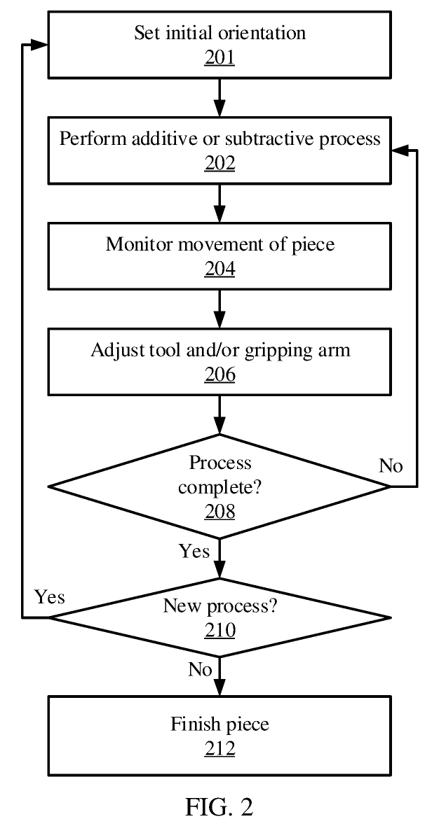

Referring now to FIG. 2, a method of performing 5D printing is shown. Block 201 sets an initial orientation using the gripping arm 110. For example, this initial orientation may be dictated by a 3D design of the piece that is being fabricated and the particular additive or subtractive process that is to be applied. The orientation positions the piece (or the empty print bed 106) relative to the tool so that the tool can add or remove material as intended.

Block 202 performs an additive or subtractive process on a piece, adding or removing material from the piece respectively. Block 204 monitors movement of the piece, for example using vibration sensor 112 and/or camera 113, to determine whether the additive or subtractive process is causing motion that interferes with the correct fabrication of the piece. Block 206 then adjusts the tool and/or the gripping arm 110 to compensate for any such motion.

Block 208 determines whether the additive or subtractive process is complete. If not, then processing returns to block 202, with the monitoring 204 being performed continuously while the additive or subtractive process 202 continues. Adjustments 206 are made as needed.

Once that particular process is complete, block 210 determines whether a new process is needed. For example, processing may switch between additive and subtractive processes or may change between types of additive or subtractive processes. In some cases the change may involve performing the same process on a different surface of the piece or at a different angle. In any such case, processing may return to block 201 and a new initial orientation may be set. The monitoring 204 of the movement of the piece during the next additive or subtractive process 202 may be performed to stabilize the piece under the new forces being applied.

Eventually all of the additive and subtractive processes have been performed and block 212 finishes the piece. Any appropriate finishing processes may be performed, such as releasing the piece from the gripper arm 110 and/or releasing the piece from the print bed 106. In some cases, finishing the piece may include post-manufacturing quality control, for example using inspection equipment such as coordinate measuring machines and structured light scanners to evaluate the piece’s dimensional accuracy and surface integrity against design specifications.

Block 212 may further include fine-tuning adjustments based on the quality control data, for example using subtractive processes to remove any deviations or imperfections that are detected in the piece. Additional analysis that may be performed at this point includes thermal and structural analysis to ensure that the piece has not been compromised during manufacturing.

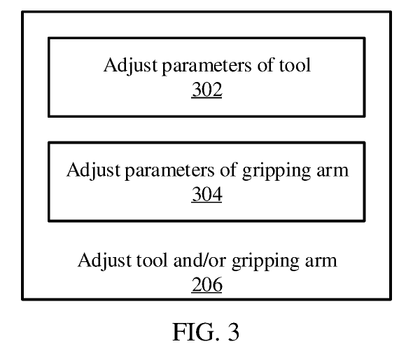

Referring now to FIG. 3, additional detail is shown on the adjustment of the tool and/or gripping arm 206. Block 302 adjusts parameters of the tool, for example by adjusting a filament feed rate, a spindle speed of a tool such as a mill or drill, or a laser intensity. Adjusting these parameters changes the rate at which material is added to, or removed from, the piece.

The adjustment of tool parameters may be determined through real-time analysis of sensor data, including feedback from the vibration sensor 112 and cameras 113. The error detection 120 analyzes this data to identify specific types and magnitudes of unwanted movement. For example in the subtractive process, when vibration amplitude exceeds predetermined thresholds, spindle speed may be incrementally reduced. Or for additive processes, filament feed rate may be modulated based on detected layer alignment from camera feedback.

Block 304 adjusts parameters of the gripping arm 110, for example by adjusting a positioning of the gripping arm or adjusting a gripping force. In some cases the adjustment may include changing a force exerted by the gripping arm to counteract a force applied by the tool, to prevent the action of the tool from moving the piece out of position. Parameter adjustments may be determined through force analysis, such as by a vibration sensor that measures frequency and amplitude of piece movement; force sensors, if installed, in the gripping arm that measure current grip force and external forces; and cameras that track spatial displacement of the object from its intended position. When tool forces are detected in a specific direction, the gripping arm applies an equal and opposite counterforce to provide a compensatory response. The system recalculates the center of mass of the object as material is added or removed, and adjusts grip position and grip force distribution across contact points with the object if needed.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 400 contains an example of an environment for the execution of at least some of the computer code involved in performing the inventive methods, such as robotic collaboration 419. In addition to block 200, computing environment 400 includes, for example, computer 401, wide area network (WAN) 402, end user device (EUD) 403, remote server 404, public cloud 405, and private cloud 406. In this embodiment, computer 401 includes processor set 410 (including processing circuitry 420 and cache 421), communication fabric 411, volatile memory 412, persistent storage 413 (including operating system 422 and block 200, as identified above), peripheral device set 414 (including user interface (UI) device set 423, storage 424, and Internet of Things (IoT) sensor set 425), and network module 415. Remote server 404 includes remote database 430. Public cloud 405 includes gateway 440, cloud orchestration module 441, host physical machine set 442, virtual machine set 443, and container set 444.

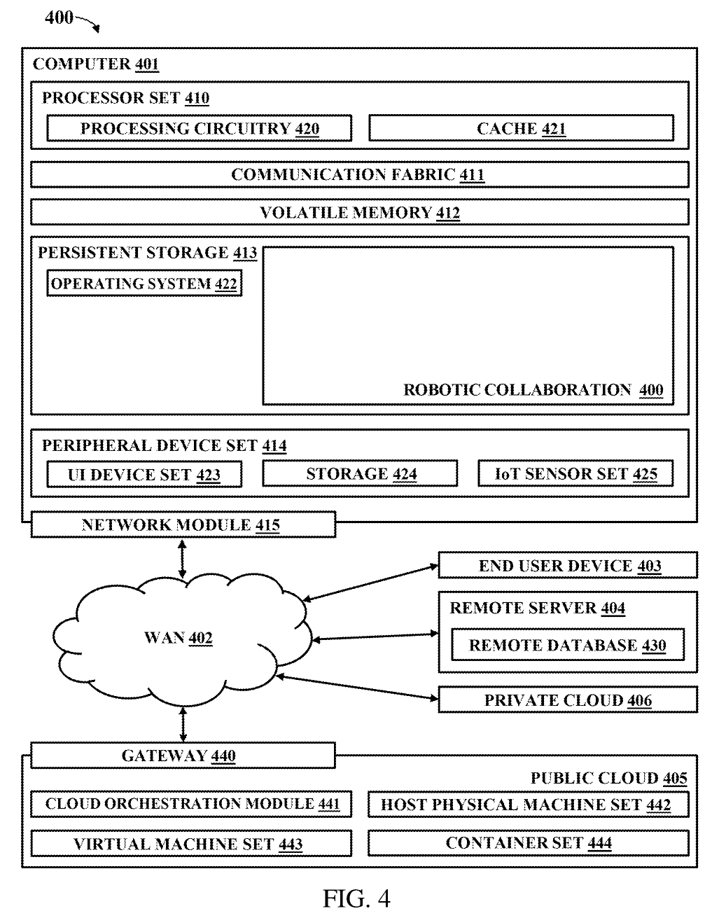

COMPUTER 401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically computer 401, to keep the presentation as simple as possible. Computer 401 may be located in a cloud, even though it is not shown in a cloud in FIG. 4. On the other hand, computer 401 is not required to be in a cloud except to any extent as may be affirmatively indicated.

PROCESSOR SET 410 includes one, or more, computer processors of any type now known or to be developed in the future. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set may be located “off chip.” In some computing environments, processor set 410 may be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 421 and the other storage media discussed below. The program instructions, and associated data, are accessed by processor set 410 to control and direct performance of the inventive methods. In computing environment 400, at least some of the instructions for performing the inventive methods may be stored in block 200 in persistent storage 413.

COMMUNICATION FABRIC 411 is the signal conduction path that allows the various components of computer 401 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

VOLATILE MEMORY 412 is any type of volatile memory now known or to be developed in the future. Examples include dynamic type random access memory (RAM) or static type RAM. Typically, volatile memory 412 is characterized by random access, but this is not required unless affirmatively indicated. In computer 401, the volatile memory 412 is located in a single package and is internal to computer 401, but, alternatively or additionally, the volatile memory may be distributed over multiple packages and/or located externally with respect to computer 401.

PERSISTENT STORAGE 413 is any form of non-volatile storage for computers that is now known or to be developed in the future. The non-volatility of this storage means that the stored data is maintained regardless of whether power is being supplied to computer 401 and/or directly to persistent storage 413. Persistent storage 413 may be a read only memory (ROM), but typically at least a portion of the persistent storage allows writing of data, deletion of data and re-writing of data. Some familiar forms of persistent storage include magnetic disks and solid state storage devices. Operating system 422 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 414 includes the set of peripheral devices of computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 423 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some embodiments, storage 424 may take the form of a quantum computing storage device for storing data in the form of qubits. In embodiments where computer 401 is required to have a large amount of storage (for example, where computer 401 locally stores and manages a large database) then this storage may be provided by peripheral storage devices designed for storing very large amounts of data, such as a storage area network (SAN) that is shared by multiple, geographically distributed computers. IoT sensor set 425 is made up of sensors that can be used in Internet of Things applications. For example, one sensor may be a thermometer and another sensor may be a motion detector.

NETWORK MODULE 415 is the collection of computer software, hardware, and firmware that allows computer 401 to communicate with other computers through WAN 402. Network module 415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 415 are performed on the same physical hardware device. In other embodiments (for example, embodiments that utilize software-defined networking (SDN)), the control functions and the forwarding functions of network module 415 are performed on physically separate devices, such that the control functions manage several different network hardware devices. Computer readable program instructions for performing the inventive methods can typically be downloaded to computer 401 from an external computer or external storage device through a network adapter card or network interface included in network module 415. WAN 402 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 403 is any computer system that is used and controlled by an end user (for example, a customer of an enterprise that operates computer 401), and may take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 401 through WAN 402 to EUD 403. In this way, EUD 403 can display, or otherwise present, the recommendation to an end user. In some embodiments, EUD 403 may be a client device, such as thin client, heavy client, mainframe computer, desktop computer and so on.

REMOTE SERVER 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data may be provided to computer 401 from remote database 430 of remote server 404.

PUBLIC CLOUD 405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 405 is performed by the computer hardware and/or software of cloud orchestration module 441. The computing resources provided by public cloud 405 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444. It is understood that these VCEs may be stored as images and may be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware, and firmware that allows public cloud 405 to communicate through WAN 402. Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 406 is similar to public cloud 405, except that the computing resources are only available for use by a single enterprise. While private cloud 406 is depicted as being in communication with WAN 402, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 405 and private cloud 406 are both part of a larger hybrid cloud.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments of 5D printing with dynamically collaborating robotic systems (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A method for five-dimensional (5D) printing, comprising:
monitoring motion of a piece held by a gripping arm during an automated manufacturing process; and
adjusting a parameter of the automated manufacturing process or of the gripping arm to compensate for the motion.

2. The method of claim 1, wherein the parameter includes a parameter of the automated manufacturing process selected from the group consisting of filament feed rate, spindle speed, and laser intensity.

3. The method of claim 1, wherein the parameter includes a parameter of the gripping arm selected from the group consisting of a gripping force and a force against a tool of the manufacturing process.

4. The method of claim 1, wherein monitoring the motion includes sensing vibration using a vibration sensor associated with the gripping arm.

5. The method of claim 1, wherein monitoring the motion includes visual monitoring using a camera.

6. The method of claim 1, further comprising orienting the piece relative to a tool of the automated manufacturing process the automated manufacturing process, including setting an orientation in two rotational dimensions.

7. The method of claim 6, further comprising changing the orientation of the piece relative to the tool, including setting a new orientation in the two rotational dimensions.

8. The method of claim 7, further comprising repeating the monitoring the motion of the piece and adjusting the parameter in the new orientation.

9. The method of claim 1, wherein adjusting the parameter includes adjusting a parameter of both the automated manufacturing process and of the gripping arm.

10. The method of claim 1, wherein monitoring the motion of the piece includes measuring a force exerted by a tool of the automated manufacturing process and wherein adjusting the parameter includes adjusting a force exerted by the gripping arm to compensate.

11. A computer program product, comprising:
one or more computer-readable storage media; and
program instructions stored on the one or more computer-readable storage media to perform operations comprising:
monitoring motion of a piece held by a gripping arm during an automated manufacturing process; and
adjusting a parameter of the automated manufacturing process or of the gripping arm to compensate for the motion.

12. A computer system, comprising:
a processor set;
one or more computer-readable storage media; and
program instructions stored on the one or more computer-readable storage media to cause the processor set to perform operations comprising:
monitoring motion of a piece held by a gripping arm during an automated manufacturing process; and
adjusting a parameter of the automated manufacturing process or of the gripping arm to compensate for the motion.

13. The system of claim 12, wherein the parameter includes a parameter of the automated manufacturing process selected from the group consisting of filament feed rate, spindle speed, and laser intensity.

14. The system of claim 12, wherein the parameter includes a parameter of the gripping arm selected from the group consisting of a gripping force and a force against a tool of the manufacturing process.

15. The system of claim 12, wherein monitoring the motion includes sensing vibration using a vibration sensor associated with the gripping arm.

16. The system of claim 12, wherein monitoring the motion includes visual monitoring using a camera.

17. The system of claim 12, wherein the operations further include orienting the piece relative to a tool of the automated manufacturing process the automated manufacturing process, including setting an orientation in two rotational dimensions.

18. The system of claim 17, wherein the operations further include changing the orientation of the piece relative to the tool, including setting a new orientation in the two rotational dimensions.

19. The system of claim 18, wherein the operations further include repeating the monitoring the motion of the piece and adjusting the parameter in the new orientation.

20. The system of claim 12, wherein monitoring the motion of the piece includes measuring a force exerted by a tool of the automated manufacturing process and wherein adjusting the parameter includes adjusting a force exerted by the gripping arm to compensate.
